(19) United States
(12) Patent Application Publication
(10) Pub. No.: US 2007/0003468 A1
(43) Pub. Date: Jan. 4, 2007

(54) Nanocarbon producing device and nanocarbon producing method

(76) Inventors: Takeshi Azami, Tokyo (JP); Tsutomu Yoshitake, Tokyo (JP); Yoshimi Kubo, Tokyo (JP); Sumio Iijima, Tokyo (JP); Daisuke Kasuya, Tokyo (JP); Masako Yudasaka, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/555,064

(22) PCT Filed: Apr. 27, 2004
(86) PCT No.: PCT/JP04/06048

§ 371 Date: Oct. 28, 2005

(30) Foreign Application Priority Data
Apr. 30, 2003 (JP) 2003-125844

(51) Int. Cl. C01B 31/02; B01J 19/08; D01F 9/127

(52) U.S. Cl. 423/445 B; 977/844; 422/186

(57) ABSTRACT

A surface of a graphite target (139), irradiated with a laser beam (103), is formed in a plane. The graphite target (139) is held by a target holding unit (153) on a target supply plate (135). A plate holding unit (137) moves the target supply plate (135) in a translational manner, which allows an irradiation position of the laser beam (103) and the surface of the graphite target (139) to be relatively moved. A transportation pipe (141) communicated with a nanocarbon collecting chamber (119) is provided toward a direction in which a plume (109) is generated, and a generated carbon nanohorn aggregates (117) is collected in the nanocarbon collecting chamber (119).

### TECHNICAL FIELD

The present invention relates to a nanocarbon production apparatus and a method of producing a nanocarbon.

### BACKGROUND ART

Recently technological application of nanocarbon is actively studied. The nanocarbon means a carbon substance having a nanoscale fine structure, typified by a carbon nanotube, a carbon nanohorn, and the like. Among these, the carbon nanohorn has a tubular structure in which one end of the carbon nanotube formed by a cylindrically rounded graphite sheet is formed in a circular conic shape, and the carbon nanohorn is expected to be applied to various technical fields due to specific characteristics of the carbon nanohorn. Usually the carbon nanohorn is aggregated in a form, in which the circular conic portion is projected to a surface like a horn while the tube is located in the center by Van der Waals force acting between circular conic portions.

It is reported that the carbon nanohorn aggregates is produced by a laser evaporation method of irradiating the carbon substance (hereinafter also referred to as “graphite target”) of a raw material with a laser beam in an inert gas atmosphere (Iijima, S., and other six authors, Chemical Physics Letter, ELSEVIER, 309 (1999) 165-170.). In Iijima, S., and other six authors, Chemical Physics Letter, ELSEVIER, 309 (1999) 165-170, it is described that a cylindrical graphite target is rotated about an axis to irradiate a side face of the graphite target with the laser beam.

### DISCLOSURE OF THE INVENTION

However, in the case where the laser beam irradiation is performed along the side face of the cylindrical graphite target, sometimes displacement of the laser beam irradiation position is generated. Further, the graphite target surface irradiated with the laser beam once is roughened. When the roughened region is irradiated with the laser beam again, a light irradiation area is easy to change in a side face of the graphite target.

Therefore, a fluctuation in power density of the light with which the side face of the graphite target is irradiated is generated, which sometimes decreases a yield of carbon nanohorn aggregates.

In view of the foregoing, an object of the invention is to provide a technology which stably produces the carbon nanohorn aggregates in large volume. Another object of the invention is to provide a technology which stably produces the nanocarbon in large volume.

According to the invention, there is provided a nanocarbon production apparatus comprising a target holding unit which holds a sheet-like or rod-shaped graphite target; a light source which irradiates a surface of said graphite target with light; a moving unit which moves one of said graphite target and said light source relative to the other to move an irradiation position of said light in the surface of said graphite target, said graphite target being held by said target holding unit; and collecting unit which collects carbon vapor to obtain nanocarbon, the carbon vapor is vaporized from said graphite target by the irradiation of said light.

The nanocarbon production apparatus according to the invention comprises a target holding unit which holds the sheet-like or rod-shaped graphite target. The nanocarbon production apparatus of the invention also comprises a moving unit which moves one of the graphite target and the light source relative to the other. Therefore, the graphite target surface may be irradiated with the light while the relative positions of the graphite target and the light source are moved.

In the case where the conventional cylindrical graphite target surface is irradiated with the light while rotated, because a curved surface is irradiated with the light, the irradiation position displacement has a large influence on a change in irradiation angle, which results in easy generation of the fluctuation in power density. On the contrary, in the invention, since the surface of the sheet-like or rod-shaped graphite target is irradiated with the light, even if the irradiation position is displaced, the light irradiation angle is difficult to change on the graphite target surface. Therefore, the power density may easily be controlled on the surface irradiated with the light, so that the fluctuation in power density may be suppressed. Therefore, quality of nanocarbon may be stabilized, and the yield of nanocarbon may be improved. Accordingly, the nanocarbon may stably be produced in large volume.

As used herein, the term “power density” shall mean the power density of the light with which the graphite target surface is actually irradiated, namely, the power density at the light irradiation region in the graphite target surface. Further, in the invention, the graphite target surface may be formed in a plane. Therefore, the change in power density caused by the light irradiation position displacement may be suppressed more securely.

According to the invention, there is a method of producing a nanocarbon comprising a step of vaporizing carbon vapor from a sheet-like or rod-shaped graphite target by irradiating a surface of said graphite target with light while moving an irradiation position of the light; and a step of collecting said carbon vapor to obtain nanocarbon.

In a method of producing a nanocarbon according to the invention, the surface of the sheet-like or rod-shaped graphite target is irradiated with the light, so that the fluctuation in power density caused by the light irradiation position displacement may be suppressed. Therefore, the nanocarbon quality may be stabilized, and the yield of nanocarbon may further be improved. Accordingly, the nanocarbon may stably be produced in large volume.

In a nanocarbon production apparatus of the invention, said moving unit may be configured to move the irradiation position of said light while substantially keeping an irradiation angle constant at said irradiation position in the surface of said graphite target.

In a method of producing a nanocarbon of the invention, a step of irradiating the surface of said graphite target with said light such that an irradiation angle is substantially kept constant to the surface of said graphite target may be comprised.

Therefore, the graphite target surface may be irradiated with the light at a constant irradiation angle, while the graphite target is continuously fedat the light irradiationposition. Accordingly, the fluctuation in power density of the light with which the graphite target surface is irradiated may be suppressed more securely, which allows nanocarbon to be stably produced in large volume.

In a nanocarbon production apparatus of the invention, said moving unit may be configured to move the irradiation position of said light while causing said graphite target to disappear at a point irradiated with said light.

In a method of producing a nanocarbon of the invention, the irradiation position of said light may be moved in the surface of said graphite target while said graphite target is caused to disappear at a point irradiated with said light.

In the invention, the light irradiation is performed while the graphite target is moved at the light irradiation position, and the graphite target is caused to disappear from the position irradiated with the light. As used herein, the term “disappearance of graphite target” should mean that only an area having a predetermined depth is not vaporized and removed from the graphite target surface, but the irradiated area is completely removed in the depth direction and light re-irradiation is not required.

According to this configuration, the graphite target may be efficiently used while the supply and consumption of the graphite target are indexed to each other. Since the graphite target may be caused to disappear without re-irradiating the position irradiated with the light once in the graphite target surface, the graphite target may be used up by the one-time light irradiation. In the position irradiated with the light once, the fluctuation in power density is easily generated in irradiating the position again because unevenness is generated in the surface. However, this configuration may more securely suppress the fluctuation in power density of the light with which the graphite target surface is irradiated. Therefore, the nanocarbon quality may be stabilized, and the yield of nanocarbon may further be improved.

In a nanocarbon production apparatus of the invention, a control unit which controls action of said moving unit or said light source such that power density of said light, with which the surface of said graphite target is irradiated, is kept constant may further be comprised. Therefore, the power density of the light with which the graphite target surface is irradiated may be controlled more securely, which enables the configuration in which the nanocarbon having stable quality may be produced with high yield.

In a nanocarbon production apparatus of the invention, said moving unit may be configured to move said graphite target held by said target holding unit in a translational manner. The provision of a rotating mechanism which rotates the graphite target is not required by the configuration in which the graphite target is moved in the translational manner, which allows the apparatus configuration to be simplified. A fluctuation in power density of the light with which the graphite target surface is irradiated is easily suppressed by moving the rod-shaped or sheet-like graphite target in the translational manner. Therefore, the nanocarbon quality may further be stabilized. Further, the yield of nanocarbon may be improved.

In a nanocarbon production apparatus of the invention, an endless belt-shaped graphite target may be installed to be entrained between a pair of rollers such that said moving unit rotates said roller to drive said graphite target. Therefore, the graphite target may efficiently be delivered to the light irradiation position. At this point, the power density of the irradiation light becomes easy to control. The apparatus may be miniaturized by the configuration in which the endless belt-shaped graphite target is installed between the pair of rollers. In the invention, the number of rollers included in “pair of rollers” may be two or three or more.

In a nanocarbon production apparatus of the invention, said graphite target is a sheet-like graphite target wound about a rotating body, and said moving unit may be configured to push out said graphite target in the direction of the irradiation position of said light while rotates said rotating body, said graphite target being released from said rotating body. The apparatus can further be miniaturized by the configuration in which the graphite target is wound about the rotating body. The sheet-like graphite target may continuously be fed to the light irradiation position by pushing out a portion which is released from the rotating body to spread the winding in the graphite target in the direction of the light irradiation position. Further, since the amount of graphite target used in one-time production may be increased, the configuration more suitable for the volume production may be realized.

In a nanocarbon production apparatus of the invention, the nanocarbon may be carbon nanohorn aggregates.

In a method of producing a nanocarbon of the invention, the step of collecting the nanocarbon may include a step of collecting carbon nanohorn aggregates.

Therefore, the carbon nanohorn aggregates may efficiently be produced in large volume. In the invention, the carbon nanohorn constituting the carbon nanohorn aggregates may be formed in a single-layer carbon nanohorn or a multi-layer carbon nanohorn.

In the nanocarbon production apparatus, the carbon nanotube may also be the nanocarbon.

In the method of producing the nanocarbon of the invention, the step of irradiating the graphite target surface with the light may include a step of irradiating the graphite target surface with the laser beam. Therefore, because a wavelength and an orientation of the light may be kept constant, the light irradiation conditions for the graphite target surface may be controlled with high accuracy, which allows the desired nanocarbon to be selectively produced.

Thus, according to the invention, the nanocarbon may stably be produced in large volume. Further, according to the invention, the carbon nanohorn aggregates may stably be produced in large volume.

### BRIEF DESCRIPTION OF THE DRAWINGS

The above and other objects, features, and advantages of the invention will be apparent from the following description of preferred embodiments and appended drawings in which:

FIG. 1 is a side view showing a configuration of a nanocarbon production apparatus according to an embodiment;

FIG. 2 is a view showing a configuration of a nanocarbon production apparatus according to an embodiment;

FIG. 3 is a side view showing a configuration of a nanocarbon production apparatus according to an embodiment;

FIG. 4 is a side view showing a configuration of a nanocarbon production apparatus according to an embodiment;

FIG. 5 is a side view showing a configuration of a nanocarbon production apparatus according to an embodiment;

FIG. 6 is a view illustrating a shape of a graphite target which is applicable to a nanocarbon production apparatus according to an embodiment;

FIG. 7 is a view illustrating a shape of a graphite target which is applicable to a nanocarbon production apparatus according to an embodiment;

FIG. 8 is a view for explaining process management method in a nanocarbon production apparatus according to an embodiment;

FIG. 9 is a view for explaining a method of producing a nanocarbon according to an embodiment; and

FIG. 10 is a view for explaining a laser beam irradiation angle.

### BEST MODE FOR CARRYING OUT THE INVENTION

Taking the case where the nanocarbon is the carbon nanohorn aggregates as an example, preferred embodiments of a nanocarbon production apparatus and a method of producing a nanocarbon according to the invention will be described below.

### First Embodiment

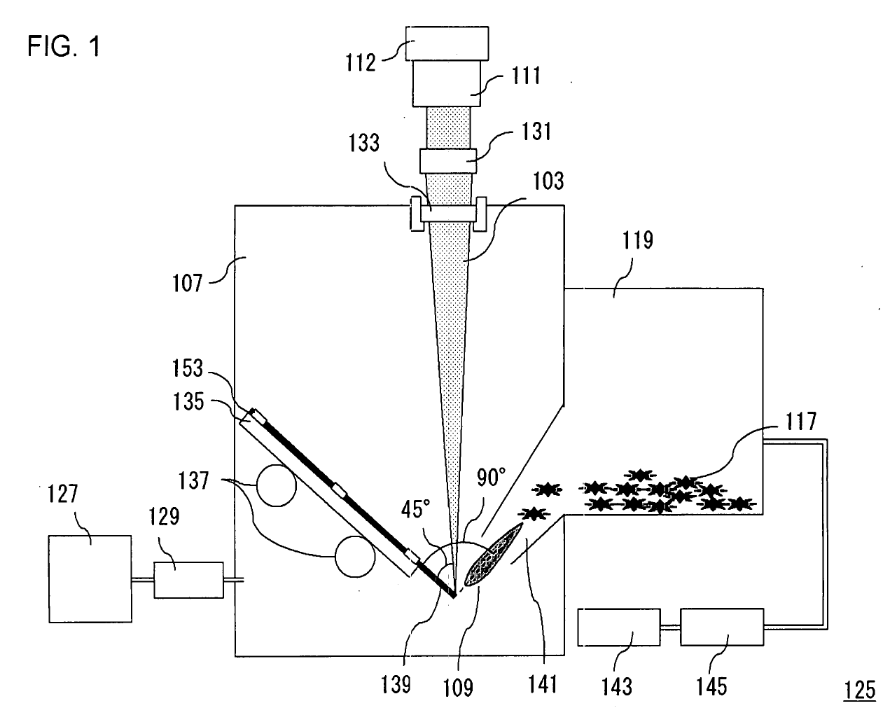

FIG. 1 is a side view showing an example of a configuration of a nanocarbon production apparatus. In the specification, FIG. 1 and other drawings used for the description are a schematic view, and the dimension of each component does not always correspond to an actual dimension ratio.

A nanocarbon production apparatus 125 of FIG. 1 includes two chambers of a producing chamber 107 and a nanocarbon collecting chamber 119. An inert gas supply unit 127 is connected to a producing chamber 107 through a flowmeter 129. A laser beam 103 outgoing from a laser source 111 held by a light source holding unit 112 is transmitted through a ZnSe planoconvex lens 131 and a ZnSe window 133, and the surface of a graphite target 139 placed in the producing chamber 107 is irradiated with the laser beam 103.

The graphite target 139 is a target made of a solid-state carbon simple substance which is irradiated with the laser beam 103. The graphite target 139 is held by the target holding unit 153 on a target supply plate 135. The plate holding unit 137 horizontally moves the target supply plate 135 in a translational manner. Therefore, when the target supply plate 135 is moved, the graphite target 139 placed thereon is also moved, which allows an irradiation position of the laser beam 103 and the surface of the graphite target 139 to be relatively moved.

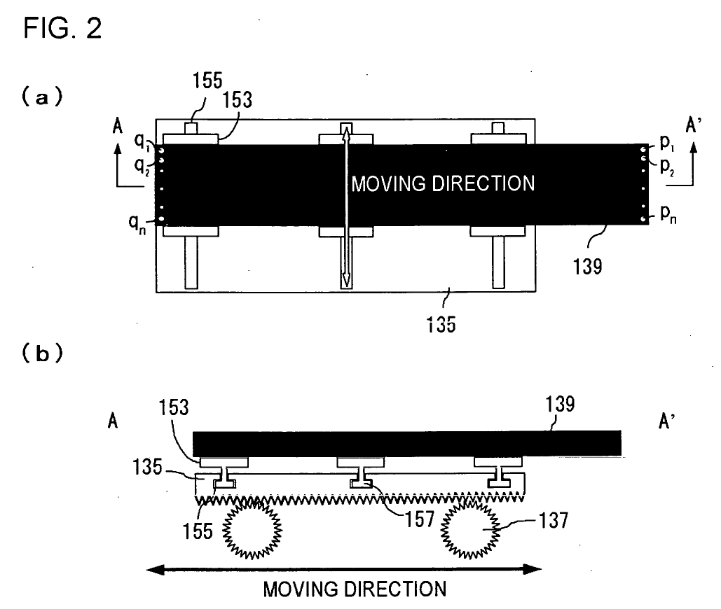

FIG. 2(a) and FIG. 2(b) are a view for explaining the detail configurations of the target supply plate 135 and the plate holding unit 137. FIG. 2(a) is a top view, and FIG. 2(b) is a sectional view taken on line A-A′ of FIG. 2(a).

Screw heads are formed in a bottom surface of the target supply plate 135 and the surface of the plate holding unit 137, and the target supply plate 135 can be moved in a horizontal direction of FIG. 2(b) in a rack and pinion. Because a convex portion 157 of the target holding unit 153 is slidably latched in a groove portion 155 of the target supply plate 135, the graphite target 139 held by the target holding unit 153 and the target holding unit 153 is configured to be able to be moved in a vertical direction of FIG. 2(a).

The above configuration enables the sheet-like graphite target 139 to be moved in a p₁-q₁ direction and a p₁-qₙ direction. Therefore, the graphite target 139 can two-dimensionally be moved in a plane, which allows the graphite target 139 to be fed at the irradiation position of the laser beam 103 outgoing from the laser source 111.

In the first embodiment, the irradiation position of the laser beam 103 is moved in the graphite target 139 such that the power density of the light on the surface of the graphite target 139 is irradiated becomes substantially constant. For example, the irradiation angle or irradiation light intensity of the laser beam 103 is adjusted. For example, in the case where the surface of the graphite target 139 is the plane, the laser source 111 is placed such that the irradiation angle of the laser beam 103 becomes constant, and the graphite target 139 can be moved in the translational manner while irradiated with the laser beam 103 at constant intensity.

Returning to FIG. 1, a transportation pipe 141 is communicated with the nanocarbon collecting chamber 119. The transportation pipe 141 is provided toward a direction in which a plume 109 is generated when the surface of the graphite target 139 is irradiated with the laser beam 103 from the laser source 111. In FIG. 1, because the surface of the graphite target 139 is irradiated with the laser beam 103 which forms an angle of 45° with the surface of the graphite target 139, the plume 109 is generated in the direction perpendicular to the surface of the graphite target 139. The transportation pipe 141 has the configuration in which a lengthwise direction of the transportation pipe 141 is arranged in the direction perpendicular to the surface of the graphite target 139. Therefore, carbon nanohorn aggregates 117 generated by cooling the carbon vapor is induced from the transportation pipe 141 to the nanocarbon collecting chamber 119, and the carbon nanohorn aggregates 117 is securely collected in the nanocarbon collecting chamber 119.

The shape of the solid-state carbon simple substance used as the graphite target 139 is not particularly limited. However, for example, the graphite target 139 is formed in sheet-like or rod-shaped. The graphite target 139 is formed in sheet-like or rod-shaped, and the irradiation angle and the intensity of the laser beam 103 with which the surface of the graphite target 139 is irradiated are kept constant. Therefore, the fluctuation in power density can be suppressed in the surface to stably produce the carbon nanohorn aggregates 117. In the case where the rod-shaped graphite target 139 is caused to slide toward the lengthwise direction of the graphite target 139 while keeping the irradiation angle of the laser beam 103 constant, the irradiation of the laser beam 103 can also be performed at constant power density in the lengthwise direction of the graphite target 139.

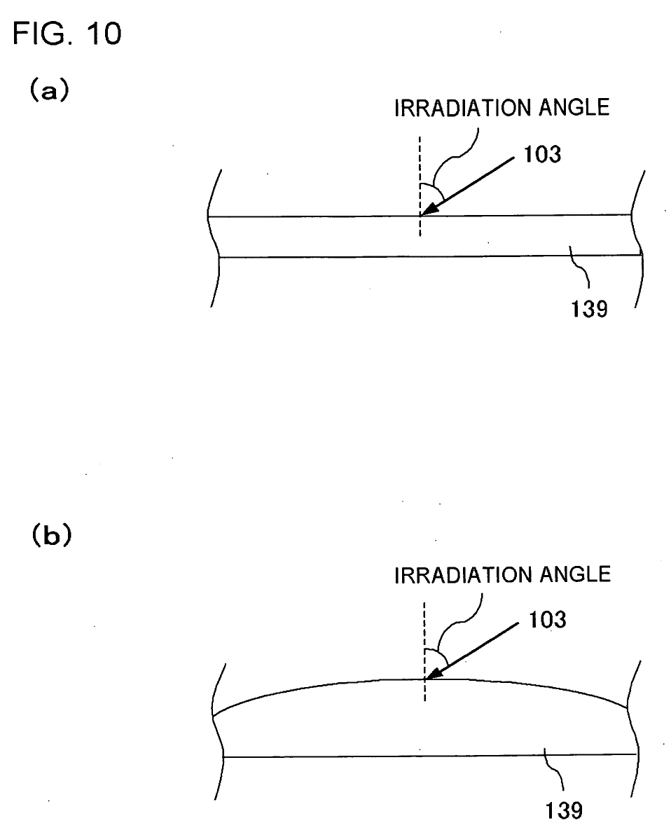

At this point, it is preferable that the irradiation angle ranges from 30° to 60°. In the first embodiment, the irradiation angle should mean the angle formed between the laser beam 103 and the perpendicular to the surface of the graphite target 139 at the irradiation position of the laser beam 103. Fig. 10 is a view for explaining the irradiation angle. FIG. 10(a) is a sectional view of the graphite target 139 when the surface of the graphite target 139 is the plane, and FIG. 10(b) is a sectional view of the graphite target 139 when the surface of the graphite target 139 is the curved surface.

When the irradiation angle is set at angles of 30° or more, reflection of the irradiation laser beam 103, i.e., the generation of optical feedback can be prevented. Direct impact of the generated plume 109 on the planoconvex lens 131 through the ZnSe window 133 is suppressed, which allows the ZnSe planoconvex lens 131 to be protected. Adhesion of the carbon nanohorn aggregates 117 to the ZnSe window 133 can also be suppressed.

When the irradiation angle is set at angles of 60° or less, the generation of amorphous carbon is suppressed, and a ratio of the carbon nanohorn aggregates 117 in the product, i.e., the yield of the carbon nanohorn aggregates 117 can be improved.

As shown in FIG. 1, it is particularly preferable that the irradiation angle is set at 45°. When the surface of the graphite target 139 is irradiated with the laser beam 103 at the angle of 45°, the ratio of the carbon nanohorn aggregates 117 in the product can further be increased to improve the yield.

Thus, in the nanocarbon production apparatus of FIG. 1, since the irradiation position of the laser beam 103 can continuously be changed in the surface of the graphite target 139, the carbon nanohorn aggregates 117 can continuously be produced. Further, since the power density of the laser beam 103 with which the surface of the graphite target 139 is irradiated can easily be kept constant, the carbon nanohorn aggregates can stably be produced with high yield.

Then, a method of producing the carbon nanohorn aggregates 117 with the production apparatus of FIG. 1 will specifically be described.

High-purity graphite, e.g., sheet-like or rod-shaped sintered carbon or compression molded carbon can be used as the graphite target 139.

The laser beam such as a high-power CO₂ gas laser beam is used as the laser beam 103.

The graphite target 139 is irradiated with the laser beam 103 in the inert gas atmosphere using rare gas such as Ar and He, e.g., at a pressure range of 10³ Pa to 10⁵ Pa. It is preferable that the inert gas atmosphere is generated after the producing chamber 107 is previously decompressed by exhausting, e.g., at a pressure of 10⁻² Pa or less by a vacuum pump 143 to which a pressure gage 145 is connected.

In order to keep the power density of the laser beam 103 constant in the surface of the graphite target 139, e.g., in order to keep the power density in the range of 20±10 kW/cm², it is preferable to adjust the output, a spot diameter, and the irradiation angle of the laser beam 103.

For example, the output of the laser beam 103 is set in the range of 1 kW or more and 50 kW or less, more specifically in the range of 3 kW to 5 kW. A pulse width of the laser beam 103 is set at a time 0.02 sec or more, preferably 0.5 sec or more, and more preferably 0.75 sec or more. Therefore, accumulation of energy of the laser beam 103 with which the surface of a graphite rod 101 is irradiated can sufficiently be secured, which allows the carbon nanohorn aggregates 117 to be efficiently produced. The pulse width of the laser beam 103 is set at a time 1.5 sec or less and preferably 1.25 sec or less. Therefore, energy density in the surface of the graphite rod 101 is fluctuated by excessively heating the surface, and the decrease in yield of the carbon nanohorn aggregates can be suppressed. It is more preferable that the pulse width of the laser beam 103 ranges 0.75 sec or more and 1 sec or less. Therefore, both a formation rate and the yield of the carbon nanohorn aggregates 117 can be improved.

In the irradiation of the laser beam 103, a down time can be set at a time 0.1 sec or more and preferably 0.25 sec or more. Therefore, overheat in the surface of the graphite rod 101 can be suppressed more securely.

As described in FIG. 1, preferably the irradiation angle of the laser beam 103 ranges 30° or more and 60° or less, and more preferably the irradiation angle set at 45°. The laser beam 103 with which the surface of the graphite target 139 can be set at a spot diameter ranging 0.5 mm or more and 5 mm or less.

The graphite target 139 is moved in the translational manner while the surface of the graphite target 139 is irradiated with the laser beam 103. At this point, it is preferable that the graphite target 139 is moved such that the spot of the laser beam 103 is moved at a speed ranging 0.01 mm/sec or more and 100 mm/sec or less. Specifically the moving speed of the graphite target 139 is set at a speed ranging 2.5 mm/sec or more and 50 mm/sec or less. When the moving speed of the graphite target 139 is set at a speed 50 mm/sec or less, the surface of the graphite target 139 is securely irradiated with the laser beam 103. When the moving speed of the graphite target 139 is set at a speed 2.5 mm/sec or more, the carbon nanohorn aggregates 117 can efficiently be produced.

A soot-like substance produced with the nanocarbon production apparatus 125 mainly contains the carbon nanohorn aggregates 117. For example, the soot-like substance is collected as the substance containing carbon nanohorn aggregates 117 by 90 wt % or more. Thus, the carbon nanohorn aggregates 117 can be obtained with high yield by using the nanocarbon production apparatus 125. The quality of the obtained carbon nanohorn aggregates 117 can be stabilized.

In the nanocarbon production appartus 125, the position of the graphite target 139 can be moved in the plane direction, so that the graphite target 139 can be used up by irradiating the graphite target 139 with the laser beam 103. Since it is not necessary to particularly provide a chamber or the like for collecting junk of the graphite target 139, the configuration of apparatus can be simplified and the apparatus can be miniaturized.

The shape, the particle size, the length, and the front end shape of the carbon nanohorn constituting the carbon nanohorn aggregates 117, the interval between carbon molecules or carbon nanohorns, and the like can be controlled in various ways by the irradiation conditions of the laser beam 103 and the like.

### Second Embodiment

A second embodiment relates to another configuration of the nanocarbon production apparatus. In the second embodiment, the same component as the nanocarbon production apparatus 125 described in the first embodiment is designated by the same numeral, and the description will not be described as appropriate.

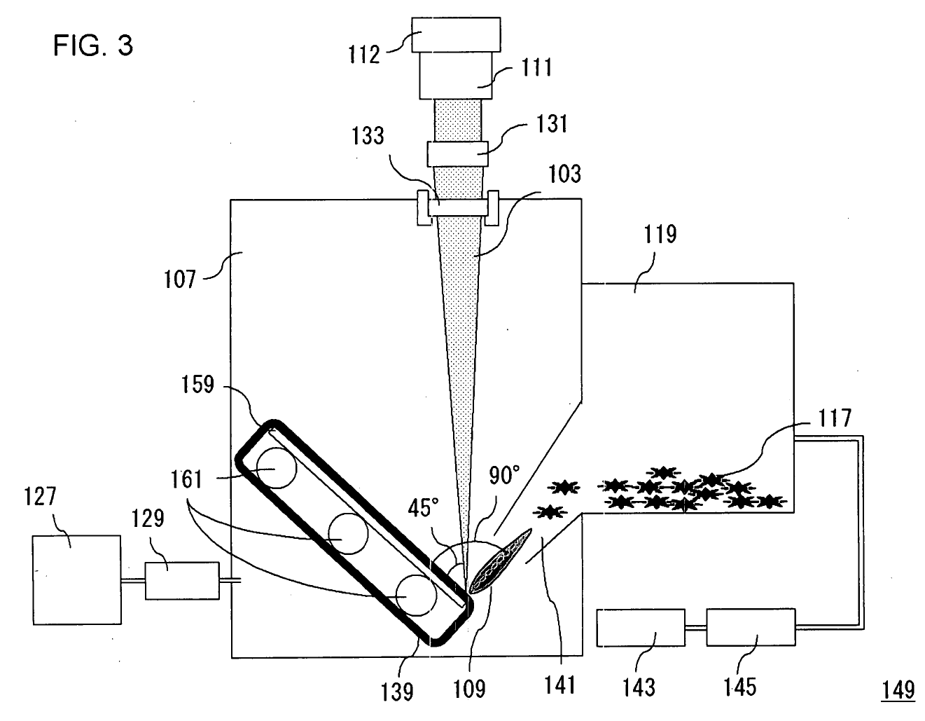

FIG. 3 is a side view showing the configuration of the nanocarbon production apparatus according to the second embodiment. A nanocarbon production apparatus 149 as shown in FIG. 3 has the configuration in which the graphite target 139 is delivered by a belt conveyer method.

In the nanocarbon production apparatus 149, a cyclic sheet of the graphite target 139 is placed on the side faces of cylindrical rollers 161 through a target holding plate 159. The irradiation position of the laser beam 103 in the surface of the graphite target 139 is moved by rotating the rollers in a predetermined direction.

In the graphite target 139, it is preferable that a portion supported by the target holding plate 159 is irradiated with the laser beam 103. The reason is as follows: In order to keep the power density of the irradiation light constant, it is preferable that the surface of the irradiation region is flat. On the other hand, in a corner portions which are not supported by the target holding plate 159, a curvature of the surface of the graphite target 139 is larger than that of the portion supported by the target holding plate 159.

The second embodiment has the configuration in which the endless belt-shaped graphite target 139 is placed on the side faces of the rollers 161 and installed between the pair of rollers 161. Therefore, the amount of graphite target 139 can be increased in one-time treatment when compared with the first embodiment. The graphite target 139 is configured to be driven by rotating the roller 161. Therefore, the smooth surface of the graphite target 139 can stably and continuously be fed at the irradiation position of the laser beam 103 by the simple configuration, which allows the configuration to be more suitable for the volume production.

In the second embodiment, as with the configuration described in the first embodiment with reference to FIG. 2, the groove portion (not shown in FIG. 3) is formed in the target holding plate 159, and the convex portion (not shown in FIG. 3) of the target holding unit (not shown in FIG. 3) is latched in the groove portion, which allows the graphite target 139 to be also moved in the direction perpendicular to the sheet of FIG. 3.

### Third Embodiment

A third embodiment relates to another configuration of the nanocarbon production apparatus. In the third embodiment, the same component as the nanocarbon production apparatus l25 or the nanocarboon production apparatus 149 described in the first and second embodiments is designated by the same numeral, and the description will be described as appropriate.

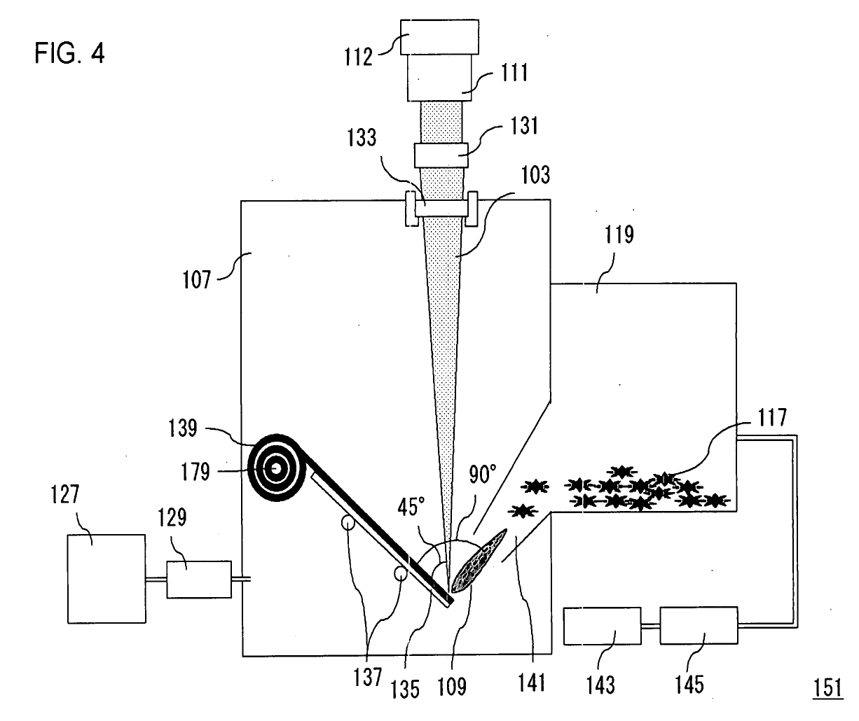

FIG. 4 is a side view showing the configuration of the nanocarbon production apparatus according to the third embodiment. Although a nanocarbon production apparatus 151 of FIG. 4 has the same basic configuration as the nanocarbon production apparatus 125 of FIG. 1, the nanocarbon production apparatus 151 differs from the nanocarbon production apparatus 125 in that the graphite target 139 is wound around a rotatable target support rod 179. The sheet-like or rod-shaped graphite target 139 is wound as a roll around the target support rod 179. An end-portion region of the graphite target 139 released from the winding of the target support rod 179 is placed on the target supply plate 135 and induced toward the light irradiation direction. The third embodiment has the configuration in which the graphite target 139 is continuously fed to the light irradiation position to obtain the carbon nanohorn aggregates 117 by sequentially delivering the graphite target 139 toward the irradiation direction of the laser beam 103.

One end of the graphite target 139 is placed on the target supply plate 135. The target support rod 179 is rotated about the center axis, and the target supply plate 135 is moved on the plate holding unit 137 in the translational manner, which feeds the graphite target 139 to the irradiation position of the laser beam 103.

In the nanocarbon production apparatus of FIG. 4, as with the configuration described in the first embodiment with reference to FIG. 2, the groove portion (not shown in FIG. 4) is formed in the target supply plate 135, and the convex portion (not shown in FIG. 4) of the target holding unit (not shown in FIG. 4) is latched in the groove portion, which allows the graphite target 139 to be also moved in the direction perpendicular to the sheet of FIG. 4.

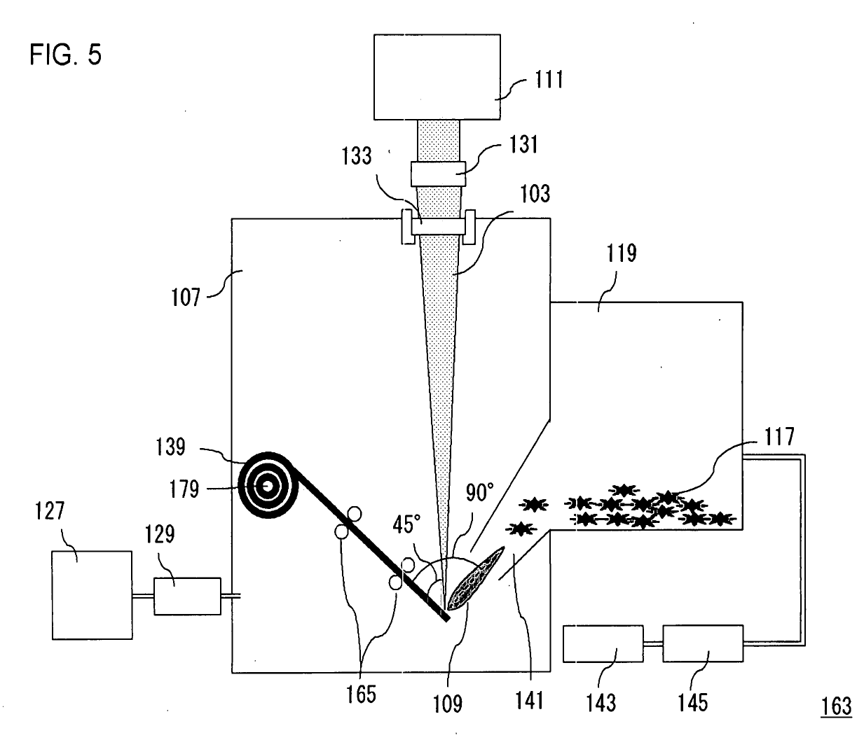

FIG. 5 is a side view showing a nanocarbon production apparatus having the different configuration in which the rollers deliver the graphite target 139. A nanocarbon production apparatus 163 of FIG. 5 has two pairs of rollers 165 which hold the graphite target 139 from both sides. The graphite target 139 is delivered toward the irradiation direction of the laser beam 103 by rotating the target support rod 179 and the rollers 165.

As shown in FIG. 4 or FIG. 5, when the roll-shaped graphite target 139 is configured to be delivered, the larger amount of graphite target 139 can be treated at one time. Therefore, the third embodiment is more available for the volume production of the carbon nanohorn aggregates 117.

It is preferable that the graphite target 139 is formed on a substrate such as a Cu plate. Therefore, a crack or a breakage generated in the graphite target 139 can be suppressed when the roll-shaped graphite target 139 is delivered. In this case, a take-up unit which taken up the substrate after the graphite target 139 is vaporized may be provided in the producing chamber 107.

### Fourth Embodiment

In the above-described first to third embodiments, a thickness of the graphite target 139 may be adjusted such that the graphite target 139 in the irradiation portion is used up when the portion is irradiated with laser beam 103 at plural times, e.g., twice. Then, a method of producing the carbon nanohorn aggregates 117 by applying the sheet-like graphite target 139 to the nanocarbon production apparatus 125 of FIG. 1 will be described as an example.

For example, in the case where the power density of the laser beam 103 with which the surface of the graphite target 139 is irradiated is set at about 20 kW/cm², the thickness of the graphite target 139 which is vaporized by the one-time irradiation of the laser beam 103 has a depth of about 3 mm from the surface. Therefore, in this case, the thickness of the graphite target 139 is set at about 6 mm.

In FIG. 2(a), the irradiation position of the laser beam 103 is moved from p₁ toward q₁ on the graphite target 139, and the graphite target 139 is reversely moved to p₁ when the graphite target 139 is irradiated to q₁. Thus, when the graphite target 139 is reciprocated once, the graphite target 139 between p₁ and q₁ is completely vaporized and disappears. Then, the irradiation position of the laser beam 103 is moved downward from p₁ to p₂ in FIG. 2(a), and similarly the graphite target 139 is reciprocated once between p₂ and q₂. The graphite target 139 can be used up by repeating the reciprocating irradiation to pₙ-qₙ.

As the number of times in the irradiation of the surface of the graphite target 139 with the laser beam 103 is increased, the irradiated surface becomes rougher, and sometimes the fluctuation of the power density is increased. However, when the thickness of the graphite target 139 is formed as described above, the fluctuation in power density can be suppressed. Therefore, the yield of the carbon nanohorn aggregates 117 can be improved.

The adjustment of the thickness of the graphite target 139 is not limited to the case in which the graphite target 139 disappears when the graphite target 139 is irradiated with the laser beam 103 twice. For example, the graphite target l39 may be set at the thickness such that the graphite target 139 disappears by the three-time irradiation of laser beam 103. In this case, the graphite target 139 may be moved in the vertical direction of FIG. 2(a) in each one and half reciprocating movements.

In the fourth embodiment, the pulse width and down time of the laser beam 103 and the moving speed of the graphite target 139 are adjusted, and the carbon nanohorn aggregates 117 may be produced on the condition that the irradiation of the laser beam 103 is not performed when the graphite target 139 disappears. Therefore, the irradiation of the components except for the graphite target 139 with the laser beam 103 due to the disappearance of the laser beam 103 can be suppressed, which allows the carbon nanohorn aggregates 117 to be more stably produced with high yield.

In the region irradiated with the laser beam 103, for example as with the nanocarbon production apparatus shown in FIG. 1 or FIG. 5, the fourth embodiment may have the configuration in which the target supply plate 135 is not provided in a lower portion of the graphite target 139. For example in the configuration shown in FIG. 3 or FIG. 4 in the irradiation position of the laser beam 103, the target supply plate 135 may also not be provided in a lower portion of the graphite target 139. Therefore, the target supply plate 135 and the like cannot directly be irradiated with the laser beam 103 just when the graphite target 139 disappears.

A buffer graphite target may be arranged in the region which is irradiated with the laser beam 103 just when the graphite target 139 disappears. Therefore, degradation of the producing chamber 107 caused by the direct irradiation of the wall surface and the like of the producing chamber 107 with the laser beam 103 can be suppressed more securely.

The graphite target 139 may be formed on the sheet made of a material which is not excited by the irradiation of the laser beam 103. Therefore, the decrease in yield of the carbon nanohorn aggregates 117 caused by the direct irradiation of the target supply plate 135 and the like with the laser beam 103 just when the graphite target 139 disappears can be suppressed.

### Fifth Embodiment

In the fourth embodiment, the thickness of the graphite target 139 may be adjusted such that the graphite target 139 in the irradiation portion is used up when the portion is irradiated with laser beam 103 once.

Since it is not necessary that the position irradiated with the laser beam 103 once is irradiated with the laser beam 103 again, the surface irradiated with the laser beam 103 is always kept smooth. Therefore, the fluctuation in power density of the laser beam 103 with which the surface of the graphite target 139 is irradiated can further be suppressed, which allows the production stability of the carbon nanohorn aggregates 117 to be further improved.

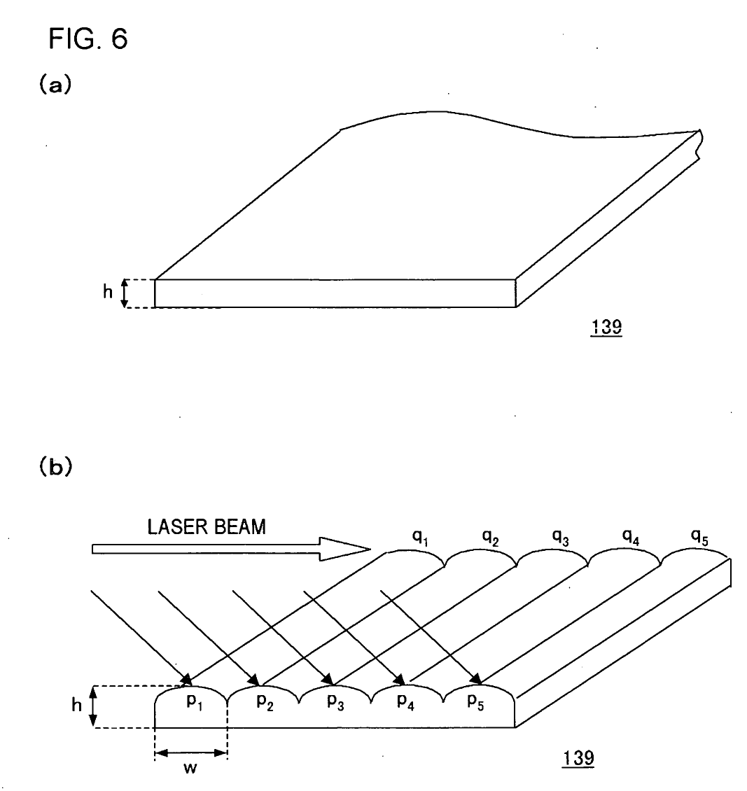

In the case where the graphite target 139 is formed in the sheet shape, for example, the shapes having the surfaces shown in FIGS. 6(i a) and 6(b) are formed.

FIG. 6(a) shows a flat plate, and the flat plate is preferable because the power density of the laser beam 103 is easily kept constant.

In FIG. 6(b), a regularly repeated structure is formed at predetermined pitches on the surface of the graphite target 139. In this case, for example when the laser beam 103 is moved in the p₁-q₁ direction, the fluctuation in power density can also be suppressed in the irradiation position.

In the case where the graphite target 139 is formed in the shape shown in FIG. 6(b), it is preferable that a width w of the repeated structure is substantially equal to the spot diameter of the laser beam 103. Therefore, the power density of the laser beam 103 with which the surface of the graphite target 139 is irradiated can be kept constant, when the graphite target 139 is irradiated with the laser beam 103 by moving the light irradiation region in the graphite target 139 in the p₁-q₁ direction, after that in the p₂-q₂ direction, . . . , and the irradiation position of the laser beam 103 is sequentially moved in the p₁-p₅ direction. Therefore, fluctuation of the power density of the laser beam 103 with which the surface of the one sheet of graphite target 139 is irradiated can be suppressed, and the carbon nanohorn aggregates 117 having the desired characteristics can stably be obtained with high yield.

The shape of the graphite target surface may have the repeated structure with the predetermined width w (pitch). The shape of the graphite target surface is not limited to the configuration shown in FIG. 6(b), and the shape can appropriately be selected.

In FIG. 6(a) and FIG. 6(b), a thickness h of the graphite target 139 is set to an extent in which the graphite target 139 is completely vaporized by the one-time irradiation of the laser beam 103 as described above. For example, when the power density of the laser beam 103 with which the surface of the graphite target 139 is irradiated is about 20 kW/cm², the thickness of the graphite target 139 vaporized by the one-time irradiation of the laser beam 103 has the depth of 3 mm from the surface, so that the thickness h can be set at about 3 mm.

In the fifth embodiment and the fourth embodiment, the graphite target 139 may be formed in the rod shape such that the width of the graphite target 139 is substantially equal to the spot diameter of the laser beam 103. Therefore, the moving direction of the graphite target 139 can be set only in the A-A′ direction of FIG. 2(a). Accordingly, it is not necessary to form the movable mechanism by combining the groove portion 155 and the convex portion 157 between the target supply plate 135 and the target holding unit 153, the apparatus configuration can further be simplified.

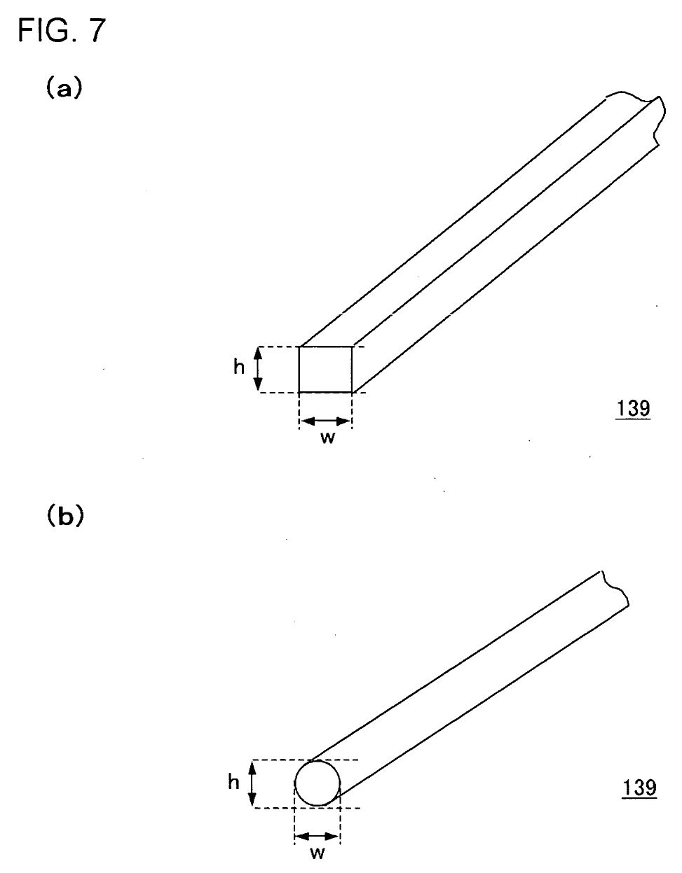

FIG. 7 is a view showing an example of the shape of the rod-shaped graphite target 139. FIG. 7(a) shows a quadratic prism graphite target 139, and FIG. 7(b) shows a cylindrical graphite target 139. The shapes of the graphite target 139 are not limited to the shapes shown in FIGS. 7(a) and 7(b). It is preferable that the graphite target 139 has a fixed cross-sectional shape. The fixed cross-sectional shape enables the suppression of the fluctuation in power density of the laser beam 103 with which the surface of the graphite target 139 is irradiated.

It is preferable that the maximum width w of the graphite target 139 is less than or equal to the spot diameter of the laser beam 103. Therefore, the laser beam 103 may be moved only in the lengthwise direction of the graphite target 139, and the production process can be simplified. It is preferable that the thickness h of the graphite target 139 is less than or equal to the spot diameter of the laser beam 103. Therefore, the graphite target at the irradiation position can securely be caused to disappear by the one-time irradiation of the laser beam 103.

Both the width w and the thickness h are less than or equal to the spot diameter of the laser beam 103, and the surface of the graphite target 139 is irradiated with the laser beam 103 along the lengthwise direction of the rod-shaped laser beam 103. Therefore, the graphite target 139 can be used up by the one-time irradiation.

Further, similarly to the fourth embodiment, the fifth embodiment can be applied to the nanocarbon production apparatus shown in FIG. 3 and FIG. 4.

### Sixth Embodiment

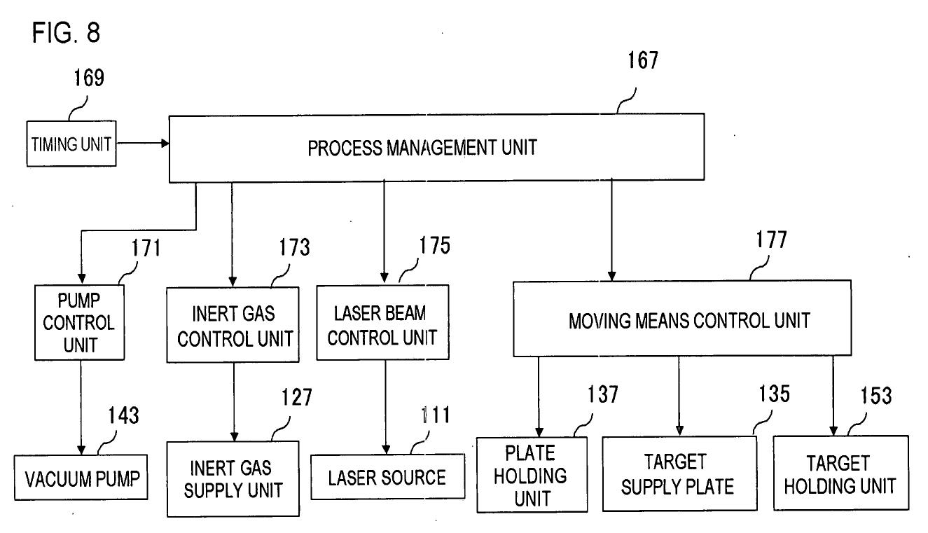

For example, process management in the above embodiments can be performed as follows. FIG. 8 is a view for explaining the process management method in the above nanocarbon production apparatus.

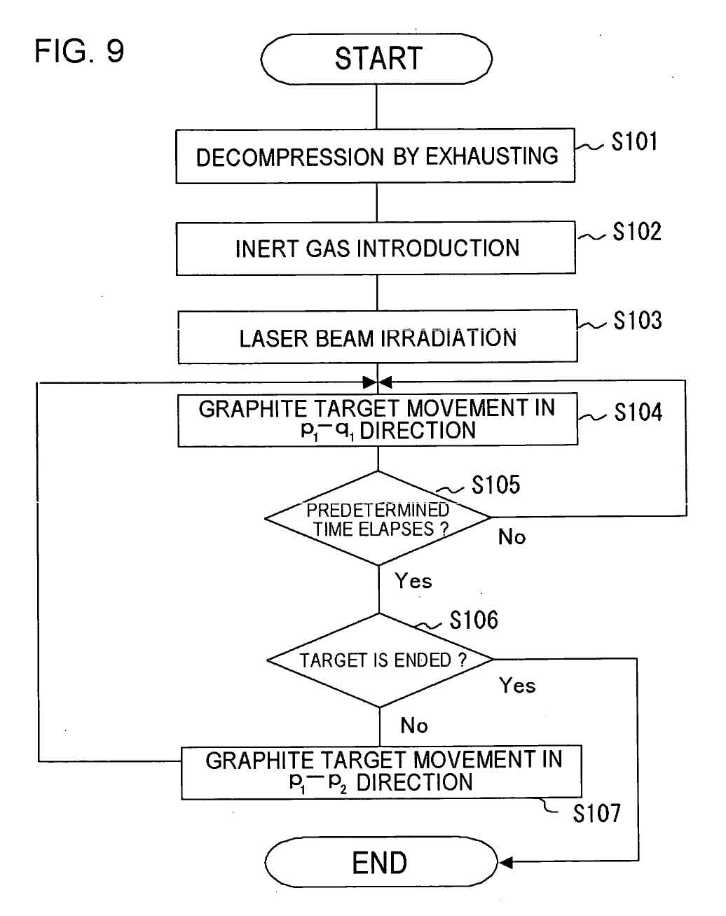

Referring to FIG. 8, a process management unit 167 performs schedule management of each process based on time information inputted from a timing unit 169. The case in which the nanocarbon production apparatus 125 (Fig. 1 and FIG. 2) of the first embodiment is used in the fourth embodiment will be described as an example of the schedule management with reference to a flowchart of FIG. 9.

First, a pump control unit 171 drives the vacuum pump 143 to decompress by exhausting the nanocarbon collecting chamber 119 and the producing chamber 107 communicated therewith (S101). When the decompression by exhausting is performed for a predetermined time, the vacuum pump 143 is stopped, and an inert gas control unit 173 supplies the constant amount of inert gas from the inert gas supply unit 127 into the producing chamber 107 (S102). Then, a laser beam control unit 175 performs the irradiation of the laser beam 103 (not shown in FIG. 8) having the predetermined intensity from the laser source 111 (S103).

A moving means control unit 177 rotates the plate holding unit 137 tomove the target supply plate 135 at a predetermined speed (S104). The step S104 corresponds to the movement of the graphite target 139 in the p-q direction in FIG. 2(a), and the graphite target 139 is moved such that, for example, the irradiation position of the laser beam 103 is reciprocated once between p₁ and q₁ in the surface of the graphite target 139.

When a predetermined time elapses (Yes in S105), and when the graphite target is not used up (No in S106), the moving means control unit 177 moves the position of the target holding unit 153 latched in the target supply plate 135 (S107), and the steps from the step S104 are repeated. The step S107 corresponds to the movement of the graphite target 139 in the p₁-pₙ direction in FIG. 2(a), and the irradiation position of the laser beam 103 is moved, e.g., from p₁ to pₙ.

The graphite target 139 is completely used to end the production of the carbon nanohorn aggregates 117 by repeating the above operation until the graphite target 139 is used up (Yes in S106).

The above steps are managed by the process management unit 167.

In the process management shown in FIG. 8, the moving means control unit 177 may relatively move one of the graphite target 139 and the laser source 111 with respect to the other to move the irradiation position of the laser beam 103 in the surface of the graphite target 139. For example, the sixth embodiment may have the configuration in which the moving means control unit 177 adjusts the irradiation angle of the laser source 111 irradiating the surface of the graphite target 139 with the laser beam 103. Further, the sixth embodiment may have the configuration in which the irradiation of the laser beam 103 is performed while the laser beam control unit 175 changes the outgoing light intensity of the laser beam 103. Therefore, the power density of the laser beam 103 with which the graphite target 139 is irradiated can be adjusted more precisely.

Thus, the embodiments of the invention are described with reference to the drawings. However, the above embodiments are illustrated by way of example only, and various configurations could be adopted besides the above embodiments.

For example, in the above embodiments, the case in which the carbon nanohorn aggregates is produced is described as an example of the nanocarbon. However, the nanocarbon produced with the nanocarbon production apparatus according to the embodiments is not limited to the carbon nanohorn aggregates.

For example, the carbon nanotube can also be produced with the nanocarbon production apparatus according to the embodiments. In the case where the carbon nanotube is produced, it is preferable that the output, the spot diameter, and the irradiation angle of the laser beam 103 are adjusted such that the power density of the laser beam 103 is kept constant, e.g. the power density is in the range of 50±10 kW/cm² in the surface of the graphite target 139.

Metal catalyst, e.g., ranging 0.0001 wt % or more and 5 wt % or less is added into the graphite target 139. Metal such as Ni and Co can be used as the metal catalyst.

The graphite target 139 can continuously be delivered to the irradiation position of the laser beam 103 by using the nanocarbon production apparatus according to the embodiments. Therefore, in the production of the carbon nanotube, the carbon nanotube can stably be produced in large volume.

The pieces of apparatus shown in FIG. 1, FIG. 3, FIG. 4, and FIG. 5 have the configuration in which the soot-like substance obtained by the irradiation of the laser beam 103 is collected in the nanocarbon collecting chamber 119. In addition, the soot-like substance can be collected by depositing the soot-like substance on a proper substrate, or the soot-like substance can be collected by the method of collecting fine particles with a dust bag. Further, the inert gas can also be circulated in the reaction chamber to collect the soot-like substance by a flow of the inert gas.

In the pieces of apparatus shown in FIG. 1, FIG. 3, FIG. 4, and FIG. 5, the irradiation position of the laser beam 103 is fixed and the graphite target 139 is moved, which relatively moves the positions of the laser beam 103 and the graphite target 139. However, the relative positions may be changed by holding the laser source 111 with the moving unit to move the laser beam 103.

1. A nanocarbon production apparatus comprising:
a target holding unit which holds a sheet-like or rod-shaped graphite target;
a light source which irradiates a surface of said graphite target with light;
a moving unit which moves one of said graphite target held by said target holding unit and said light source relative to the other to move an irradiation position of said light in the surface of said graphite target; and
a collecting unit for collecting carbon vapor evaporated from the graphite target by irradiation with light, as nanocarbon

2. A nanocarbon production apparatus according to claim 1, wherein said moving unit is configured to move the irradiation position of said light while substantially keeping an irradiation angle constant at said irradiation position in the surface of said graphite target.

3. A nanocarbon production apparatus according to claim 1, wherein said moving unit is configured to move the irradiation position of said light while causing said graphite target located at a point irradiated with said light to disappear, said graphite target.

4. A nanocarbon production apparatus according to claim 1, further comprising a control unit which controls action of said moving unit or said light source such that power density of said light irradiated to the surface of said graphite target is kept constant.

5. A nanocarbon production apparatus according to claim 1, wherein said moving unit moves said graphite target held by said target holding unit in a translational manner.

6. A nanocarbon production apparatus according to claim 1, wherein said graphite target is configured to drive it by installing an endless belt-shaped graphite target is between a pair of rollers, and rotating said roller with said moving unit.

7. A nanocarbon production apparatus according to claim 1, wherein said graphite target is a sheet-like graphite target wound about a rotating body, and said moving unit is configured to push out said graphite target released from said rotating body toward the direction of irradiation position of said light while rotates said rotating body.

8. A nanocarbon production apparatus according to claim 1, wherein said nanocarbon is carbon nanohorn aggregates.

9. A method of producing a nanocarbon comprising:
vaporizing carbon vapor from a sheet-like or rod-shaped graphite target by irradiating a surface of said graphite target with light while moving an irradiation position of the light; and
collecting said carbon vapor to obtain nanocarbon.

10. A method of producing a nanocarbon according to claim 9, further comprising:
irradiating the surface of said graphite target with said light such that an irradiation angle is substantially kept constant to the surface of said graphite target.

11. A method of producing a nanocarbon according to claim 9, the irradiation position of said light is moved in the surface of said graphite target while said graphite target is caused to disappear at a point irradiated with said light.

12. A method of producing a nanocarbon according to claim 9, wherein said nanocarbon is carbon nanohorn aggregates.
